(19) United States
(12) Patent Application Publication
(10) Pub. No.: US 2019/0373854 A1
(43) Pub. Date: Dec. 12, 2019

(54) ANIMAL IDENTIFYING DEVICE, AND METHOD AND PROGRAM FOR CONTROLLING ANIMAL IDENTIFYING DEVICE

(71) Applicant: SHARP KABUSHIKI KAISHA, Osaka (JP)

(72) Inventor: YOSHIO SATOH, Osaka (JP)

(21) Appl. No.: 16/430,822

(22) Filed: Jun. 4, 2019

(30) Foreign Application Priority Data
Jun. 8, 2018 (JP) 2018-110676

(51) Int. Cl. A01K 11/00; A01K 1/01; G01G 19/52; G01G 19/414

(52) U.S. Cl. CPC A01K 11/006; G01G 19/414; G01G 19/52; A01K 1/0107

(57) ABSTRACT

An individual-identifying device identifies, from among a plurality of pets, an unidentified pet which has entered an animal toilet 1, with use of evaluation values which are weighted on the basis of (i) a body weight of the unidentified pet and (ii) information indicating the respective strengths of a plurality of signals respectively received from a plurality of ID information transmission devices respectively worn by the plurality of pets.

This Nonprovisional application claims priority under 35 U.S.C. § 119 on Patent Application No. 2018-110676 filed in Japan on Jun. 8, 2018, the entire contents of which are hereby incorporated by reference.

### TECHNICAL FIELD

The present invention relates to: an animal identifying device which identifies, from among a plurality of animals, an animal which has entered a predetermined region; a method of controlling the animal identifying device; and a program.

### BACKGROUND ART

Recently, owners of animals such as pets have come to place importance on daily management of animal health. For example, in order to ascertain the health of a pet, it is important to measure, e.g., the body weight of the pet. Patent Document 1 discloses an automated body weight measurement system for a pet which is installed below a resting place for a pet. The system measures the weight of the resting place in both (i) a state where the pet is on the resting place and (ii) a state where the pet is not on the resting place. The system calculates the weight of the pet and then outputs the weight by displaying the weight. Patent Document 1 discloses that the system wirelessly reads the identification information of the pet, which is recorded in an RF tag worn by the pet, so as to identify the pet. The system displays the name of the identified pet along with the weight.

### CITATION LIST

### Patent Literature

[Patent Literature 1]

Japanese Patent Application Publication Tokukai No. 2007-330200 (Publication date: Dec. 27, 2007)

### SUMMARY OF INVENTION

### Technical Problem

However, the prior art as described above has the problem that, when a plurality of pets are in the vicinity of the body weight measurement system at the same time, it is difficult to identify which pet is on the scale. The present invention has been made in view of the above problem. An object of the present invention is to provide an animal identifying device capable of identifying, from among a plurality of pets, an animal which has entered a predetermined region.

### Solution to Problem

In order to solve the above problem, an animal identifying device in accordance with an aspect of the present invention includes: a body weight calculating section which calculates a body weight of an unidentified animal among a measurement target animal group constituted by a plurality of animals which are subject to body weight measurement, the body weight calculating section calculating the body weight of the unidentified animal on the basis of weight information from a measurement carried out while the unidentified animal is in a predetermined region; a signal strength acquiring section which acquires information indicating a strength of each of a plurality of signals respectively transmitted from a plurality of transmission devices respectively worn by the plurality of animals constituting the measurement target animal group; a signal information determining section which determines identity-determining signal information for identifying the unidentified animal, the identity-determining signal information being based on the respective strength of each signal received; a weighted evaluation value calculating section which calculates (i) weighted body weight evaluation values, which are weighted in accordance with the body weight of the unidentified animal and (ii) weighted signal evaluation values, which are weighted in accordance with the identity-determining signal information; and an individual-identifying section which identifies the unidentified animal which has entered the predetermined region on the basis of the weighted body weight evaluation values and the weighted signal evaluation values.

In order to solve the above problem, a method in accordance with an aspect of the present invention is a method of controlling an animal identifying device, the method including: a body weight calculation step of calculating a body weight of an unidentified animal among a measurement target animal group constituted by a plurality of animals which are subject to body weight measurement, the body weight of the unidentified animal being calculated on the basis of weight information from a measurement carried out while the unidentified animal is in a predetermined region; a signal strength acquisition step of acquiring information indicating a strength of each of a plurality of signals respectively transmitted from a plurality of transmission devices respectively worn by the plurality of animals constituting the measurement target animal group; a signal information determination step of determining identity-determining signal information for identifying the unidentified animal, the identity-determining signal information being based on the respective strength of each signal received; a weighted evaluation value calculation step of calculating (i) weighted body weight evaluation values, which are weighted in accordance with the body weight of the unidentified animal and (ii) weighted signal evaluation values, which are weighted in accordance with the identity-determining signal information; and an individual identification step of identifying the unidentified animal which has entered the predetermined region on the basis of the weighted body weight evaluation values and the weighted signal evaluation values.

### Advantageous Effects of Invention

An aspect of the present invention makes it easy to identify, from among a plurality of animals, an animal which has entered a predetermined region, even in a case where sudden noise occurs in a measured body weight or signal.

### BRIEF DESCRIPTION OF DRAWINGS

FIG. 1 is a block diagram illustrating a configuration of main parts of a management system in accordance with Embodiment 1.

FIG. 2 is a diagram illustrating an overview of the management system in accordance with Embodiment 1.

FIG. 3 consists of flowcharts in accordance with Embodiment 1. Flowchart 301 of FIG. 3 illustrates an example of processing carried out by an entry/exit determining section in accordance with Embodiment 1. Flowchart 302 of FIG. 3 illustrates an example of processing carried out by an identification processing section in accordance with Embodiment 1.

FIG. 4 consists of flowcharts in accordance with Embodiment 1. Flowchart 401 of FIG. 4 illustrates processing carried out by an individual-confirming section in accordance with a variation of Embodiment 1. Flowchart 402 of FIG. 4 illustrates processing carried out by an individual-confirming section in accordance with another variation of Embodiment 1.

FIG. 5 is a graph showing examples of weights indicated by information acquired by a weight acquiring section in accordance with Embodiment 1.

FIG. 6 consists of graphs illustrating examples of measurement data in a case where a pet is using an animal toilet. Graph 601 of FIG. 6 is a graph of obtained weight values, and graph 602 of FIG. 6 is a graph of RSSI values.

FIG. 7 is a graph illustrating an example of how a body weight calculating section in accordance with Embodiment 1 calculates body weight from weights detected by a scale.

FIG. 8 consists of graphs illustrating other examples of measurement data in a case where a pet is using an animal toilet. Graph 801 of FIG. 8 is a graph of obtained weight values, and graph 802 of FIG. 8 is a graph of RSSI values.

FIG. 9 consists of flowcharts illustrating example flows of processing for calculating weighted evaluation values. Flowchart 901 of FIG. 9 illustrates an example flow of processing for calculating weighted strength evaluation values. Flowchart 902 of FIG. 9 illustrates an example flow of processing for calculating weighted body weight evaluation values.

FIG. 10 is a flowchart illustrating an example flow of processing for calculating weighted change amount evaluation values.

FIG. 11 is a block diagram illustrating a configuration of main parts of a management system in accordance with Embodiment 2 of the present invention.

FIG. 12 is a flowchart illustrating an example of processing carried out by an entry/exit determining section in accordance with Embodiment 2 of the present invention.

FIG. 13 is a graph showing examples of sensor values detected by a proximity sensor in accordance with Embodiment 2 of the present invention.

FIG. 14 is a block diagram illustrating a configuration of main parts of a management system in accordance with Embodiment 3.

### DESCRIPTION OF EMBODIMENTS

### Embodiment 1

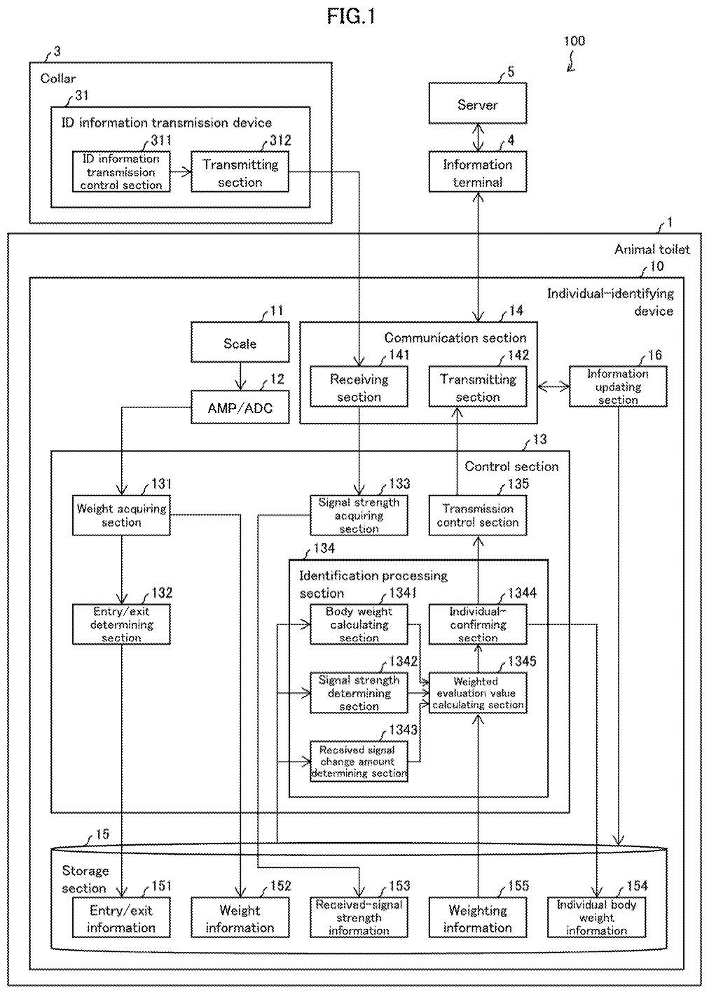

The following description will discuss an embodiment of the present invention with reference to FIGS. 1 to 10. Discussed here is an example involving a pet management system which includes a pet toilet, the pet toilet including an animal identifying device in accordance with an aspect of the present invention. Note that an animal identifying device in accordance with the present invention is not limited to the example mode discussed here. For example, the animal identifying device may be employed in a place regularly visited by an animal subject to body weight measurement (for example, a place for sleeping or feeding).

(Overview of Pet Management System 100)

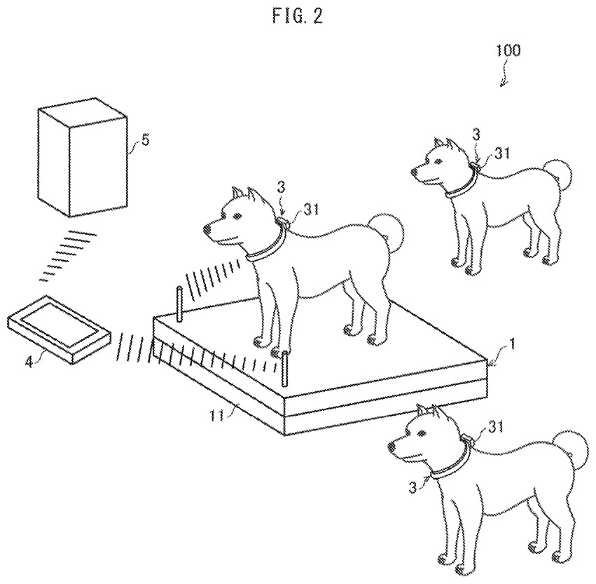

With reference to FIG. 2, discussed first is an overview of a pet management system in accordance with Embodiment 1. FIG. 2 is a diagram illustrating an overview of a pet management system 100. The pet management system 100 includes an animal toilet 1 (a predetermined region), a collar 3, an information terminal 4, and a server 5. The animal toilet 1 includes a scale 11. The collar 3 includes an ID information transmission device (transmission device) 31 which transmits identification (ID) information. As described later, the animal toilet 1 includes an individual-identifying device (animal identifying device) 10 in accordance with Embodiment 1. The individual-identifying device 10 identifies, from among a plurality of pets, a pet which has entered the animal toilet 1.

The individual-identifying device 10 of Embodiment 1 can be used effectively in, for example, a case where a user keeps a plurality of pets. Discussed next are the inventors' discoveries and the background thereof.

The inventors carried out diligent study of how to improve the accuracy of identification in a case where a plurality of pets are kept. The inventors set about trying to improve the accuracy of pet identification by using the body weights of pets and information indicated by signals respectively transmitted from information transmission devices respectively worn by each pet. In testing, the inventors observed that factors other than just distance between a pet and the animal toilet 1 can cause fluctuations in the strength of a received signal (hereinafter also referred to as RSSI). The inventors thus researched the cause of such fluctuations. As a result, the inventors found that RSSI can fluctuate (i.e., that noise can occur) due to, for example, the orientation and size of the body of a pet, and actions of a pet. Radio waves transmitted from an ID information transmission device 31 do not pass through the body of a pet but are rather propagated around the pet. As such, RSSI presumably decreases in a case where a pet is oriented such that the body of the pet is between the collar 3 and a receiver of the individual-identifying device 10. Furthermore, a larger pet body correlates to a greater likelihood of a decrease in RSSI. In the case of a pet (such as a cat) that may carry out an action of peering into the receiver, such an action by the pet can cause an increase inn RSSI.

Sudden noise can also occur in a body weight measured at the animal toilet 1. It is presumably possible to improve the accuracy of pet identification by using a camera and processing images that the camera captures, but such a method would increase the complexity and cost of the individual-identifying device. As such, there is the need to improve the accuracy of pet identification via a simple method.

In view of the above findings, the individual-identifying device 10 of Embodiment 1 is configured to identify a pet with use of evaluation values which are calculated by carrying out weighting on the basis of body weight information and signal information. This reduces the effect of the above-described noise and makes it possible to easily identify, from among a plurality of animals, an animal which has entered a predetermined region. Furthermore, as described later, by changing the conditions of the weighting, it is possible to improve the accuracy of pet identification in accordance with the various circumstances of cases where a plurality of pets are kept. Once a pet is identified, the body weight of the identified pet is, for example, transmitted to the information terminal 4 and the server 5.

(Configuration of Pet Management System 100)

Discussed next, with reference to FIG. 1, are details of a configuration of the pet management system 100. FIG. 1 is a block diagram illustrating a configuration of main parts of the pet management system 100, which identifies, from among a plurality of pets, a pet which has entered the animal toilet (predetermined region) 1.

(Collar 3)

The collar 3 is worn by a pet. The collar 3 includes an ID information transmission device 31. The ID information transmission device 31 includes an ID information transmission control section 311 and a transmitting section 312. The ID information transmission control section 311 transmits, to the individual-identifying device 10 via the transmitting section 312, a signal indicating identification (ID) information of the pet which is wearing the collar 3. The transmitting section 312 transmits the signal to the individual-identifying device 10 with use of, for example, short range wireless communication (such as Bluetooth (registered trademark)).

(Pets)

Typical examples of pets to identified by the individual-identifying device 10 (pets which a user keeps a plurality of) include dogs and cats. The type of pet in Embodiment 1 is not particularly limited, provided that the pet is a type of animal that uses the animal toilet 1. In the present specification, a group made up of a plurality of pets (animals) that are subject to body weight measurements (i.e., a group made up of the plurality of pets kept by a user) may be referred to as a “measurement target animal group”. Each pet in the measurement target animal group wears a collar 3 as described above.

(Animal Toilet 1)

In addition to serving as a pet toilet, the animal toilet 1 also measures the body weight of a pet. The animal toilet 1 includes the individual-identifying device 10. The individual-identifying device 10 may be configured to transmit measurement data, such as the body weight of a pet, to the information terminal 4 with use of, for example, short range wireless communication (such as Bluetooth (registered trademark)). The information terminal 4 may be configured to display measurement data such as the received body weight of the pet. The information terminal 4 may be configured to cause the server 5 to store measurement data such as the received body weight of the pet. Examples of the information terminal 4 include a smartphone, a personal computer (PC), a personal digital assistant (PDA), and a tablet device. Examples of the server 5 include a cloud server.

(Individual-Identifying Device 10)

As illustrated in FIG. 1, the individual-identifying device 10 includes a scale 11, an amp (amplifier) and analog-to-digital converter (ADC) 12, a control section 13, a communication section 14, a storage section 15, and an information updating section 16.

(Scale 11)

The scale 11 detects a weight on the animal toilet 1 and transmits the detected value to a weight acquiring section 131. In other words, the scale 11 can be described as detecting entry/exit of a pet into/from the animal toilet 1. The scale 11 is, for example, a load cell. The scale 11 may transmit a detected value to a weight acquiring section 131 via the amp and ADC 12. The amp amplifies a received detected value. The ADC converts the detected value received as an analog signal into a digital signal.

(Control Section 13)

As illustrated in FIG. 1, the control section 13 includes the weight acquiring section 131, an entry/exit determining section (timing confirming section) 132, a signal strength acquiring section 133, an identification processing section 134, and a transmission control section 135.

(Weight Acquiring Section 131)

The weight acquiring section 131 acquires information indicating the weight on the animal toilet 1 by receiving a value detected by the scale 11. The weight acquiring section 131 transmits the information indicating the weight on the animal toilet 1 to the entry/exit determining section 132. The weight acquiring section 131 also updates weight information 152 which is stored in the storage section 15. The weight information 152 indicates a weight on the animal toilet 1 in association with a time of detection

(Entry/Exit Determining Section 132; Flow of Processing Carried out by Entry/Exit Determining Section 132)

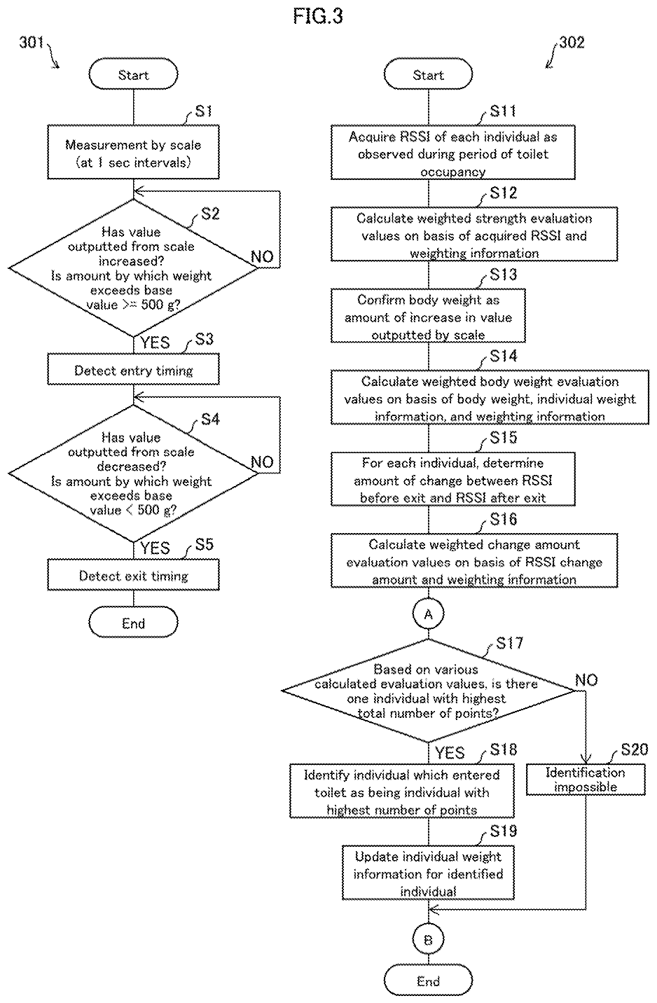

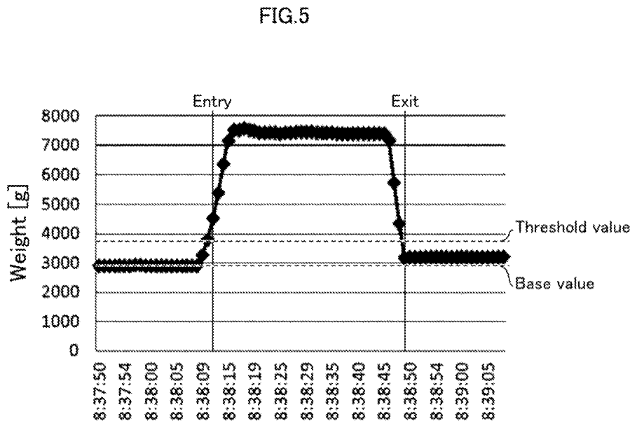

The entry/exit determining section 132 detects that a pet has entered the animal toilet 1, on the basis of a change in the weight on the animal toilet 1 as indicated by information acquired by the weight acquiring section 131. More specifically, the entry/exit determining section 132 confirms the timing of entry/exit of a pet into/from the animal toilet 1, on the basis of a change in the weight on the animal toilet 1. A flow of processing carried out by the entry/exit determining section 132 will be discussed here with reference to flowchart 301 of FIG. 3 and to FIG. 5. Flowchart 301 of FIG. 3 illustrates an example of processing carried out by the entry/exit determining section 132. FIG. 5 is a diagram showing examples of weights (body weights) indicated by information acquired by the weight acquiring section 131.

As illustrated in flowchart 301 of FIG. 3, the entry/exit determining section 132 acquires information indicating the weight at predetermined intervals (e.g., 1 second intervals) (measurement by scale) (Step 1; hereinafter abbreviated as “S1”; other steps are abbreviated similarly as well). As illustrated in FIG. 5, the entry/exit determining section 132 uses, as a base value, a weight as indicated by information acquired while no pet is in the animal toilet 1. Subsequently, the entry/exit determining section 132 determines whether or not the weight (output value of the scale 11) indicated by the received information has increased. More specifically, the entry/exit determining section 132 determines whether or riot an amount by which the weight indicated by the received information exceeds the base value is greater than or equal to 500 g (threshold value) (S2). In a case where, as illustrated in FIG. 5, the amount by which the weight indicated by the information received by the entry/exit determining section 132 exceeds the base value is greater than or equal to 500 g (threshold value)(“YES” in S2), the entry/exit determining section 132 confirms the time point at which the amount by which the weight exceeds the base value became greater than or equal to 500 g (threshold value) as being the timing of when a pet entered the animal toilet 1 (detection of entry timing)(S3). Subsequently, the entry/exit determining section 132 determines whether or not the weight indicated by received information has decreased. Specifically, the entry/exit determining section 132 determines whether or not an amount by which the weight indicated by received information is exceeds the base value is less than 500 g (threshold value) (S4). In a case where, as illustrated in FIG. 5, the amount by which the weight indicated by information received by the entry/exit determining section 132 exceeds the base value is less than 500 g (threshold value)(“YES” in S4), the entry/exit determining section 132 confirms a time point at which the amount by which the weight exceeded the base value the became less than 500 g (threshold value) as being the timing of when the pet exited the animal toilet 1 (detection of exit timing)(S5). In a case where, in S2, the amount by which the weight indicated by received information is increased over the base value is less than 500 g (“NO” in S2), processing returns to S2. In a case where, in S4, the amount by which the weight indicated by received information exceeds the base value is greater than or equal to 500 g (“NO” in S4), the processing returns to S4. After the entry/exit determining section 132 confirms the timing of an entry or exit, the entry/exit determining section 132 updates entry/exit information 151 stored in the storage section 15. The entry/exit information 151 is information indicating the timing (time) of pet entry/exit into/from the animal toilet 1.

The above explanation uses an example in which 500 g is the threshold value of the amount by which a weight exceeds the base value, which threshold value is used for determining the timing of pet entry and exit into/from the animal toilet 1. Note, however, that this threshold value may be any value and is not particularly limited.

(Signal Strength Acquiring Section 133)

The signal strength acquiring section 133 acquires (i) information indicating the strength, at the animal toilet 1, of a signal transmitted from an ID information transmission device 31 worn by a pet, and (ii) identification information indicated by that signal. The communication section 14 (described later) may include a signal strength detecting section (not shown) which detects the strength of the signal received from the ID information transmission device 31. The signal strength acquiring section 133 receives information indicating the strength (RSSI) of the signal received from the communication section 14. The signal strength acquiring section 133 updates received-signal strength information 153, which is stored in the storage section 15. The received-signal strength information 153 is information which indicates the strength of a respective signal received from each ID information transmission device 31, in association with a time of reception.

(Identification Processing Section 134)

The identification processing section 134 includes a body weight calculating section (identity-determining information acquiring section) 1341, a signal strength determining section (signal information determining section) 1342, a received signal change amount determining section (signal information determining section) 1343, a weighted evaluation value calculating section 1345 and an individual-confirming section (individual-identifying section) 1344.

(Body weight calculating section 1341, signal strength determining section 1342, received signal change amount determining section 1343, weighted evaluation value calculating section 1345, and individual-confirming section 1344)

The body weight calculating section 1341 calculates a body weight of a pet which has entered the animal toilet 1 on the basis of a weight on the animal toilet 1 detected while that pet is in the animal toilet 1. The body weight calculating section 1341 then transmits, to the weighted evaluation value calculating section 1345, information indicating the body weight thus calculated. The signal strength determining section 1342 acquires (determines) a respective RSSI of each pet in the measurement target animal group in accordance with the received-signal strength information 153. The signal strength determining section 1342 then transmits information thus acquired to the weighted evaluation value calculating section 1345. The received signal change amount determining section 1343 determines, for each pet in the measurement target animal group, an amount of change between an RSSI as observed prior to when the pet in the animal toilet 1 exits the animal toilet 1 and an RSSI as observed after the pet in the animal toilet 1 exits the animal toilet 1, in accordance with the received-signal strength information 153. The received signal change amount determining section 1343 then transmits, to the weighted evaluation value calculating section 1345, information indicating the amount of change thus determined. For each pet in the measurement target animal group, the weighted evaluation value calculating section 1345 carries out weighting on the basis of information received from the body weight calculating section 1341, the signal strength determining section 1342, and the received signal change amount determining section 1343, so as to calculate a weighted body weight evaluation value, a weighted strength evaluation value (weighted signal evaluation value), and a weighted change amount evaluation value (weighted signal evaluation value), respectively. Details of the processing carried out by each of these sections is described later. The individual-confirming section 1344 then identifies the animal which has entered the animal toilet 1 on the basis of the various evaluation values calculated by the weighted evaluation value calculating section 1345.

(Flow of Processing Carried Out by Identification Processing Section 134)

The following description will discuss details of processing carried out by the identification processing section 134, with reference to the drawings as necessary. Flowchart 302 of FIG. 3 illustrates an example of processing carried out by the identification processing section 134. The identification processing section 134 preferably commences processing after the timing of when a pet has entered and exited the animal toilet 1 has been confirmed. For example, the entry/exit determining section 132 may be configured to transmit to the identification processing section 134 (in particular, to the body weight calculating section 1341, the signal strength determining section 1342, and the received signal change amount determining section 1343) notification that the entry/exit determining section 132 has confirmed the timing of pet entry into and exit from the animal toilet 1.

(Flow of Processing Based on Information Indicating RSSI During Toilet Occupancy)

First, the signal strength acquiring section 133 acquires information indicating the strength of each signal respectively transmitted from the ID information transmission devices 31 respectively worn by each pet, and causes the storage section 15 to store received-signal strength information 153 (signal strength acquisition step)

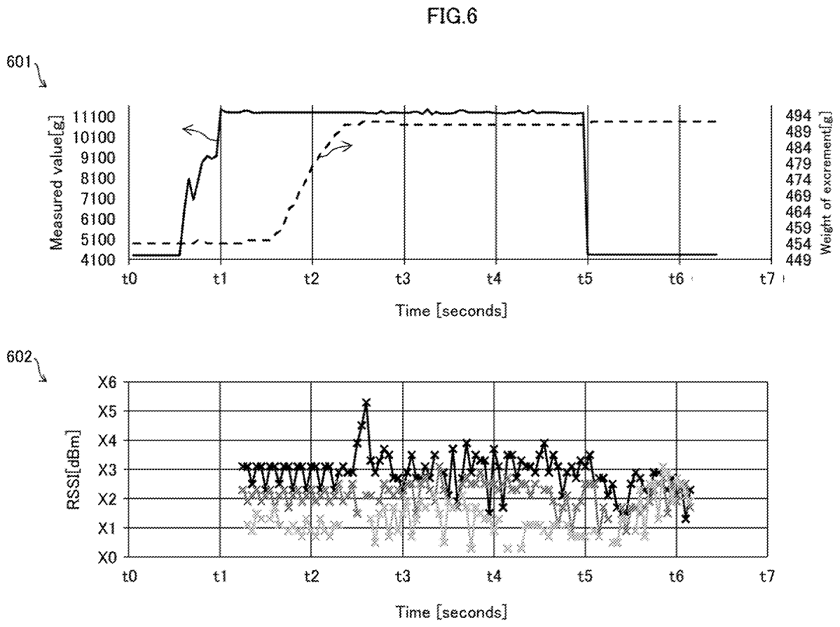

Then, as illustrated in flowchart 302 of FIG. 3, the signal strength determining section 1342 reads out the entry/exit information 151 and the received-signal strength information 153 stored in the storage section 15 so as to acquire (determine) an RSSI of each pet (each individual) of the measurement target animal group as observed during a period of toilet occupancy (a period while an animal is in a predetermined region) (S11: signal information determining step). An example of RSSI data will be discussed here with reference to FIG. 6. FIG. 6 consists of graphs illustrating examples of measurement data in a case where a pet is using the animal toilet 1. Graph 601 of FIG. 6 is a graph of obtained weight values, and graph 602 of FIG. 6 is a graph of RSSI values. In graph 602 of FIG. 6, the vertical axis represents RSSI values, where X0<X6. In other words, a higher position on the graph indicates a higher RSSI value.

In the example illustrated in graph 601 of FIG. 6, a pet entered the animal toilet 1 between time points t0 and t1 and exited the animal toilet 1 near time point t5. The signal strength determining section 1342 acquires an RSSI for each pet in the measurement target animal group. As illustrated in graph 602 of FIG. 6, during a period of toilet occupancy, the RSSI value of each pet fluctuates due to various factors. Despite these fluctuations, there is a tendency for a pet which is in the animal toilet 1 to have an RSSI value which is higher than that of other pets (than pets which are not in the toilet). As such, in individual identification processing in accordance with Embodiment 1, the RSSI data is treated as having high reliability.

Note here that, in the present specification, the wording “period of toilet occupancy” refers to a period during which an unidentified pet remains in the animal toilet 1. Furthermore, “each pet during a period of toilet occupancy” refers to each of the pets in the measurement target animal group, including the pet which is in the animal toilet 1 during the period of toilet occupancy as well as those pets which are not in the animal toilet 1.

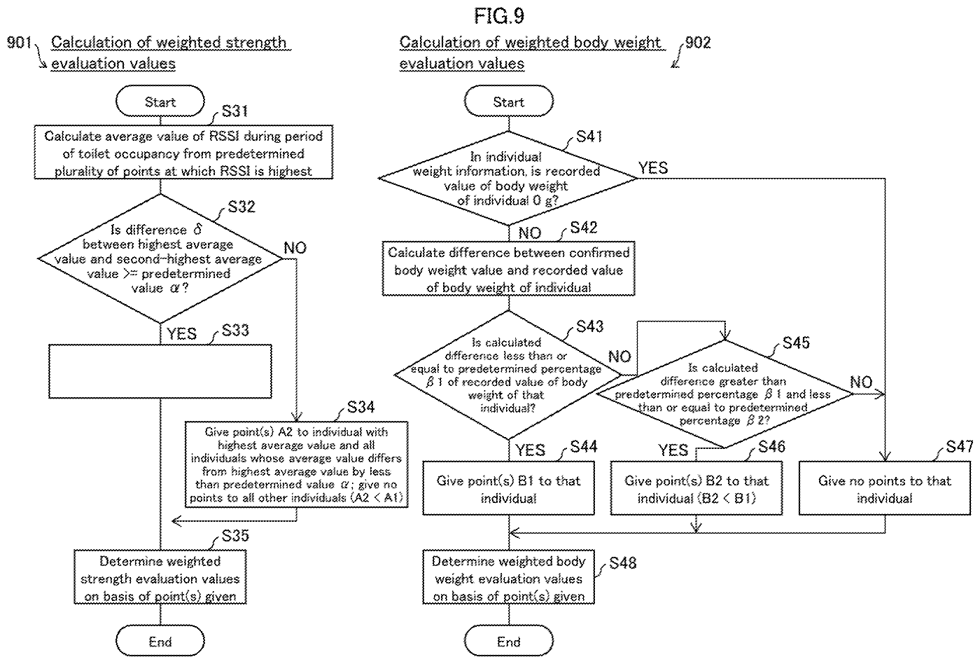

After S11, the weighted evaluation value calculating section 1345 calculates weighted strength evaluation values on the basis of (i) the respective RSSI value of each pet during a period of toilet occupancy and (ii) predetermined weighting conditions (S12: weighted evaluation value calculation step). Note that the predetermined weighting conditions may be stored as weighting information 155 in the storage section 15. The same applies to the various processing discussed below. Flowchart 901 of FIG. 9 illustrates an example flow of processing for calculating weighted strength evaluation values.

As illustrated in flowchart 901 of FIG. 9, the weighted evaluation value calculating section 1345 calculates, for each pet in the measurement target animal group, an average value of RSSI values as observed during a period of toilet occupancy. Specifically, the average value is calculated from a plurality of points (time points) exhibiting the highest RSSI values among RSSI values observed during the period of toilet occupancy. Note that the number of the plurality of points is not limited. However, once the number of the plurality of points is set, the weighted evaluation value calculating section 1345 uses that same number in calculating the average value for each pet. In other words, the weighted evaluation value calculating section 1345 calculates the average value for a predetermined plurality of points. Note also that the above manner of calculating average values is merely a non-limiting example. For example, each average value may be calculated with use of data from a plurality of points exhibiting the highest values observed specifically during a period in which (i) the toilet is occupied and (ii) RSSI values are stable. The manner in which the stability of RSSI values is decided can be set as appropriate by a designer. Alternatively, the weighted evaluation value calculating section 1345 can be configured to calculate, for each pet, an average value of all RSSI values observed during a period of toilet occupancy, or an average value of all RSSI values observed during a period in which (i) the toilet is occupied and (ii) RSSI values are stable.

In a case where a difference between the highest average value and the second highest average value is greater than or equal to a value α (predetermined value)(“YES” in S32), the pet having the highest average value is given point(s) A1, and all other pets are given no points (S33). In the case of “NO” in S32, point(s) A2 are given to (i) the pet having the highest average value and (ii) each pet having an average value whose difference from the highest value is less than the value α, and all other pets are given no points. The value of the point(s) A2 is less than that of the point(s) A1. The specific values of (i) the predetermined value α used as a threshold value (whose unit may be dBm in Embodiment 1) and (ii) the point(s) A1 and A2 are not particularly limited and may be set as appropriate by a designer. The weighted evaluation value calculating section 1345 determines a weighted strength evaluation value for each pet, on the basis of the points given in the above manner (S35).

The above-described matters can be summarized as follows. The individual-identifying device 10 of Embodiment 1 uses a respective RSSI of each pet as observed during a period of toilet occupancy (occupancy period signal strength information) as identity-determining signal information. The individual-identifying device 10 identifies a pet with use of weighted strength evaluation values, which are weighted in accordance with the occupancy period signal strength information. The weighted evaluation value calculating section 1345 is configured to (i) calculate, from the occupancy period signal strength information, respective differences in strength between (a) a signal which has a highest RSSI among the signals received from the plurality of transmission devices and (b) each of the rest of the signals received, and (ii) calculate the weighted strength evaluation values on the basis of the respective differences in strength thus calculated and a predetermined weighting criterion This configuration makes it easy to identify, from among a plurality of pets, a pet which has entered the animal toilet 1, even in a case where sudden noise occurs in a measured signal.

The weighted evaluation value calculating section 1345 may be configured to calculate a median value of RSSI values observed during a period of toilet occupancy, or a median value of RSSI values observed during a period in which (i) the toilet is occupied and (ii) RSSI values are stable. In such cases, the weighted strength evaluation values can be determined by calculating the signal strength difference for each pet with use of the calculated median value instead of the average value. The weighted evaluation value calculating section 1345 may be configured to (i) classify the RSSI values observed during a period of toilet occupancy into predetermined strength groups, and then (ii) calculate a modal value of each strength group. In such a case, the weighted strength evaluation values can be determined by calculating the signal strength difference for each pet with use of the calculated modal values instead of the average values.

(Flow of Processing Using Body Weight)

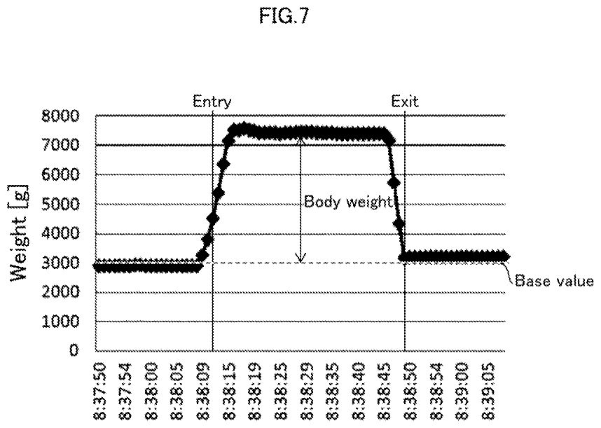

Referring again to flowchart 302 of FIG. 3, the body weight calculating section 1341 reads out the entry/exit information 151 and the weight information 152 stored in the storage section 15 and uses this information to calculate (confirm) the body weight of the pet which has entered the animal toilet 1 (S13: body weight calculation step) The following description will discuss this processing with reference to FIG. 7. FIG. 7 is a diagram illustrating an example of how the body weight calculating section 1341 calculates body weight from weights detected by the scale 11.

As illustrated in FIG. 7, while a pet is in the animal toilet 1, the body weight calculating section 1341 determines whether or not an amount of change in weight during a predetermined period (e.g., 5 seconds) is within a predetermined range (e.g., within a range of 50 g) (determination of stability of detected weight). The body weight calculating section 1341 confirms the body weight of the pet in the animal toilet 1 by calculating the difference between (i) a weight as measured when the weight is stable, as described above and (ii) base value (i.e., by calculating an amount by which the weight exceeds the base value). Hereinafter, the body weight thus confirmed is also referred to as a “confirmed body weight value.” Note that the method of calculating the base value is not described here, as it has been discussed above in the descriptions of the entry/exit determining section 132 and S1 of the processing carried out by the entry/exit determining section 132.

After S13, the weighted evaluation value calculating section 1345 reads out, from the storage section 15, individual body weight information 154 which indicates the respective body weights of the plurality of pets, and calculates weighted body weight evaluation values on the basis of (i) the body weight confirmed in S13, (ii) the individual body weight information 154, and (ii) predetermined weighting conditions (S14: weighted evaluation value calculation step). Flowchart 902 of FIG. 9 illustrates an example flow of processing for calculating weighted body weight evaluation values.

As illustrated in flowchart 902 of FIG. 9, first, the weighted evaluation value calculating section 1345 determines, for each pet in the measurement target animal group, whether a body weight of that pet is recorded in the individual body weight information 154 (S41). In a case where no body weight is recorded for a pet, i.e., in a case where the recorded body weight is 0 g (“YES” in S41), no points are given to that pet (S47). In a case where the body weight of a pet is recorded (“NO” in S41), the weighted evaluation value calculating section 1345 calculates, for that pet, a difference between the confirmed body weight value and the body weight recorded in the individual body weight information 154 (S42). This difference is calculated for each pet having a body weight recorded in the individual body weight information 154. Next, in a case where a difference calculated as above is less than or equal to a percentage β1 (first predetermined percentage) of the body weight recorded in the individual body weight information 154 (“YES” in S43), the weighted evaluation value calculating section 1345 gives point(s) B1 to the corresponding pet (S44). In a case where a difference calculated as above is (i) greater than the percentage β1 and (less than or equal to a percentage β2 (second predetermined percentage) of the body weight recorded in the individual body weight information 154 (“YES” in S45), the weighted evaluation value calculating section 1345 gives point(s) B2 to the corresponding pet (S46). Note that the value of the point(s) B2 is less than that of the points B1, and the value of the percentage β1 is less than that of the percentage β2. The specific values of the first predetermined percentage β1, the second predetermined percentage β2, the point(s) B1, and the point(s) B2 are not particularly limited and may be set as appropriate by a designer. In the case of “NO” in S45 (in a case where the difference calculated as above is greater than the percentage β2 of the body weight recorded in the individual body weight information 154), no points are given to the corresponding pet (S47). The weighted evaluation value calculating section 1345 determines a weighted body weight evaluation value for each pet, on the basis of the points given in the above manner (S48).

The above-described matters can be summarized as follows. In the individual-identifying device 10 of Embodiment 1, the weighted evaluation value calculating section 1345 calculates the weighted body weight evaluation values on the basis of (i) the body weight (confirmed body weight value) that has been determined, (ii) recorded respective body weights of the pets as recorded in the individual body weight information 154, and (iii) a predetermined weighting criterion. The individual-confirming section 1344 then identifies a pet with use of the weighted body weight evaluation values and the weighted signal evaluation values, as described later. Information based on signals can be treated as having higher reliability than information based on body weight. This configuration makes it easy to identify, from among a plurality of pets, a pet which has entered the animal toilet 1, even in a case where sudden noise occurs in a measured body weight.

Note that the step S41 may be omitted in the flowchart illustrated in flowchart 902 of FIG. 9.

(Flow of Processing Using Information Indicating Amount of Change Between RSSI Before Exit and RSSI after Exit)

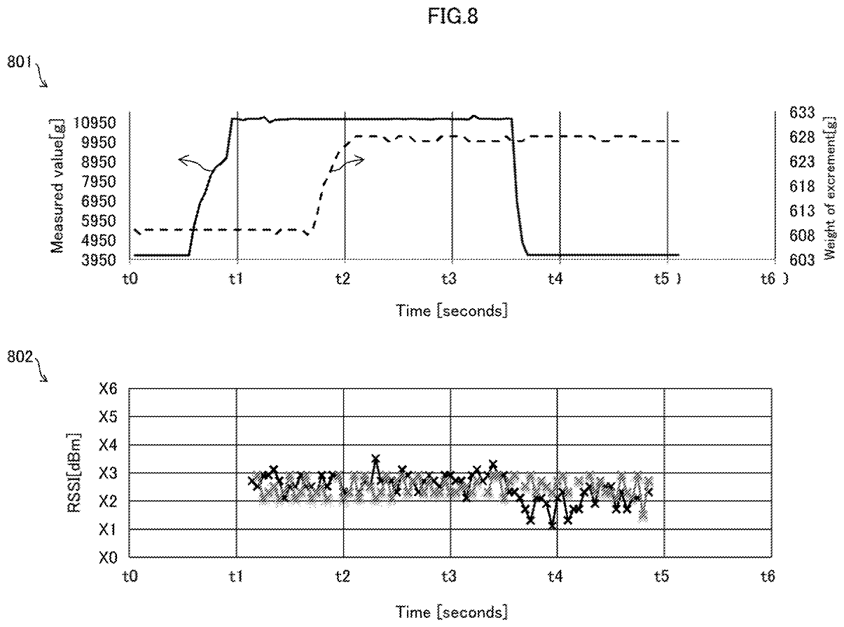

Referring again to flowchart 302 of FIG. 3, the received signal change amount determining section 1343 reads out the entry/exit information 151 and the received-signal strength information 153 stored in the storage section 15. The received signal change amount determining section 1343 determines, for each pet (each individual) in the measurement target animal group, an amount of change between (i) RSSI as observed prior to when the pet in the animal toilet 1 exits the animal toilet 1 and (ii) RSSI as observed after the pet in the animal toilet 1 exits the animal toilet 1 (i.e., the received signal change amount determining section 1343 acquires signal strength change amount information) (S15: signal information determination step). An example of RSSI data will be discussed here with reference to FIG. 8. FIG. 8 consists of graphs illustrating other examples of measurement data in a case where a pet is using the animal toilet 1. Graph 801 of FIG. 8 is a graph of obtained weight values, and graph 802 of FIG. 8 is a graph of RSSI values.

Graph 801 of FIG. 8 is similar to graph 601 of FIG. 6 as described above, and a description of such is therefore omitted here. In the example of graph 802 of FIG. 8, there is no large difference between the respective RSSI values of each pet during the period of toilet occupancy. However, in a comparison of RSSI values prior to and after the time point at which a pet occupying the toilet exits, a significant attenuation (change) of RSSI can be observed. The following description will discuss an example method of determining an amount of change in RSSI. In the example of graph 802 of FIG. 8, the received signal change amount determining section 1343 determines the maximum RSSI value observed during a Y1 number of seconds prior to when a pet occupying the animal toilet 1 exits the animal toilet 1. The received signal change amount determining section 1343 also determines the minimum RSSI value observed during a Y2 number of seconds after the pet occupying the animal toilet 1 exits the animal toilet 1. As another example, there are cases in which, in a comparison of RSSI values prior to and after a time point at which a pet occupying the toilet exits, a significant increase in RSSI can be observed. In such cases, the received signal change amount determining section 1343 identifies a minimum RSSI value in the Y1 number of seconds and a maximum RSSI value in the Y2 number of seconds. Then, for each pet in the measurement target animal group, the received signal change amount determining section 1343 determines the amount of change in RSSI to be the difference between the maximum RSSI value and the minimum RSSI value. The specific values of Y1 and Y2 are not particularly limited and may be set as appropriate by a designer. Y1 and Y2 can each be, for example, a single-digit value.

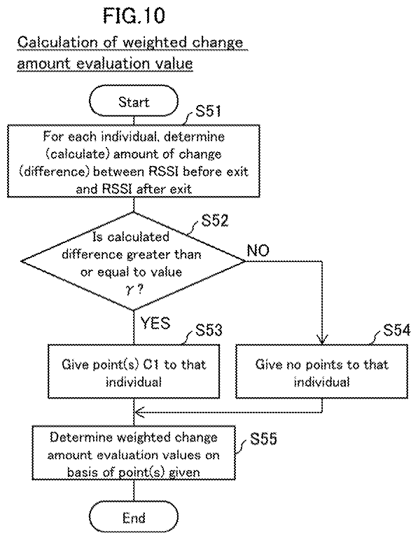

After S15, the weighted evaluation value calculating section 1345 calculates, for each pet, a weighted change amount evaluation value (weighted strength change amount evaluation value), on the basis of the amount of change in RSSI for each pet and predetermined weighting conditions (S16: weighted evaluation value calculation step). FIG. 10 is a flowchart illustrating an example flow of processing for calculating weighted change amount evaluation values.

As illustrated in FIG. 10, for each pet in the measurement target animal group, the received signal change amount determining section 1343 determines an amount of change in RSSI by calculating a difference between (i) RSSI as observed prior to when a pet in the animal toilet 1 exits the animal toilet 1 and (ii) RSSI as observed after the pet in the animal toilet 1 exits the animal toilet 1 (S51). In a case where the amount of change in RSSI for a pet is greater than or equal to a value γ (“YES” in S52), point(s) C1 are given to that pet (S53). In a case where the amount of change in RSSI for a pet is less than the value γ (“NO” in S52), no points are given to that pet. The specific values of (i) the value γ used as a threshold value (whose unit may be dBm in Embodiment 1) and (ii) the number of the point(s) C1 are not particularly limited and may set as appropriate by a designer. The weighted evaluation value calculating section 1345 determines a weighted change amount evaluation value for each pet, on the basis of the points given in the above manner (S55).

The above-described matters can be summarized as follows. In the individual-identifying device 10 of Embodiment 1, identity-determining signal information includes signal strength change amount information which indicates an amount of change between (i) RSSI as observed prior to when a pet in the animal toilet 1 has exited the animal toilet 1 and (ii) RSSI as observed after the pet in the animal toilet 1 has exited the animal toilet 1. The individual-identifying device 10 identifies a pet with use of weighted strength change amount evaluation values, which are weighted on the basis of the signal strength change amount information. The weighted evaluation value calculating section 1345 calculates weighted change amount evaluation values on the basis of the signal strength change amount information and a predetermined weighting criterion. With this configuration, even in a case where, for example, there are a plurality of pets for which the sum of the weighted strength evaluation value and the weighted body weight evaluation value is the same, using the weighted change amount evaluation values makes it possible to easily identify, from among a plurality of pets, a pet which has entered the animal toilet 1.

(Processing Carried Out by the Individual-Confirming Section 1344)

Referring again to flowchart 302 of FIG. 3, the individual-confirming section 1344 receives, from the weighted evaluation value calculating section 1345, the weighted strength evaluation values, the weighted body weight evaluation values, and the weighted change amount evaluation values obtained in the processing of S11 to S16. In a case where, based on the various evaluation values, there is one pet having the highest total number of points (“YES” in S17), the individual-confirming section 1344 identifies the pet which has entered the animal toilet 1 as being the pet having the highest total number of points (S18: individual identification step). Thereafter, the individual-confirming section 1344 updates the individual body weight information 154 for the individual thus identified (S19). In a case where there is not one single pet having the highest total number of points (“NO” in S17), the individual-confirming section 1344 determines that the pet which has entered the animal toilet 1 cannot be identified (S20). The individual-confirming section 1344 may be configured to transmit, to the transmission control section 135, information indicating the confirmed individual and information indicating the body weight of the confirmed individual.

(Transmission Control Section 135)

The transmission control section 135 controls transmission of data to an external device. In Embodiment 1 in particular, the transmission control section 135 receives, from the individual-confirming section 1344, information indicating the confirmed pet and the body weight of that pet, and then transmits the information to the information terminal 4 via the communication section 14.

(Communication Section 14)

The communication section 14 communicates with an external device(s). In particular, in Embodiment 1, the communication section 14 communicates with the information terminal 4 and the ID information transmission device 31. The communication section 14 includes a receiving section 141 which receives data from an external device(s) and a transmitting section 142 which transmits data to an external device(s). In particular, in Embodiment 1, the receiving section 141 receives a signal indicating the identification information of a pet from the ID information transmission device 31 via short range wireless communication.

(Storage Section 15)

The storage section 15 stores the entry/exit information 151, the weight information 152, the received-signal strength information 153, the individual body weight information 154, and the weighting information 155. The weighting information 155 stores threshold values which, for the purpose of carrying out identification processing, are referred to by, for example, the body weight calculating section 1341, the signal strength determining section 1342, and the received signal change amount determining section 1343. The server 5 or the information terminal 4 may be configured to store the entry/exit information 151, the weight information 152, the received-signal strength information 153, the individual body weight information 154, and the weighting information 155. In such a case, the identification processing section 134 may be configured to receive necessary information as appropriate via the receiving section 141.

(Information Updating Section 16)

The information updating section 16 updates the individual body weight information 154 and the weighting information 155 in accordance with communication between the communication section 14 and the information terminal 4. The information updating section 16 may, for example, update, in accordance with information transmitted from the user's information terminal 4, the body weight of each pet recorded in the individual body weight information 154. The information updating section 16 may change (update), in accordance with information transmitted from the information terminal 4 or the server 5, weighting conditions included in the weighting information 155.

(Advantageous Effect)

As described above, the individual-identifying device 10 of Embodiment 1 brings about the effect of making it easy to identify, from among a plurality of animals, an animal which has entered a predetermined region, even in a case where sudden noise occurs in a measured body weight or signal.

[Variation]

(a) In the processing carried out by the individual-identifying device 10 as illustrated in flowchart 302 of FIG. 3, the order of the processing of S11 to S16 is not particularly limited. The processing of each of S11 to S16 may be carried out in parallel.

(b) An individual-identifying device in accordance with a variation of Embodiment 1 may be configured such that the weighting conditions included in the weighting information 155 are set in advance in the weighted evaluation value calculating section 1345 (for example, the weighting conditions may be incorporated in a program in advance). In such a case, the weighting information 155 does not need to be stored in the storage section 15.

(c) The individual-identifying device 10 in accordance with Embodiment 1 was described as identifying an individual on the basis of a total number of points which is obtained by the individual-confirming section 1344 summing up various evaluation values. An individual-identifying device in accordance with a variation of Embodiment 1 may be alternatively configured so that the individual-confirming section 1344 includes a weighted evaluation value calculating section 1345. In such a case, the individual-confirming section 1344 may calculate a final total number of points by adding points for each pet while calculating a weighted body weight evaluation value on the basis of body weight information and a weighted signal evaluation value on the basis of signal information and giving point(s) to each pet based on these evaluation values.

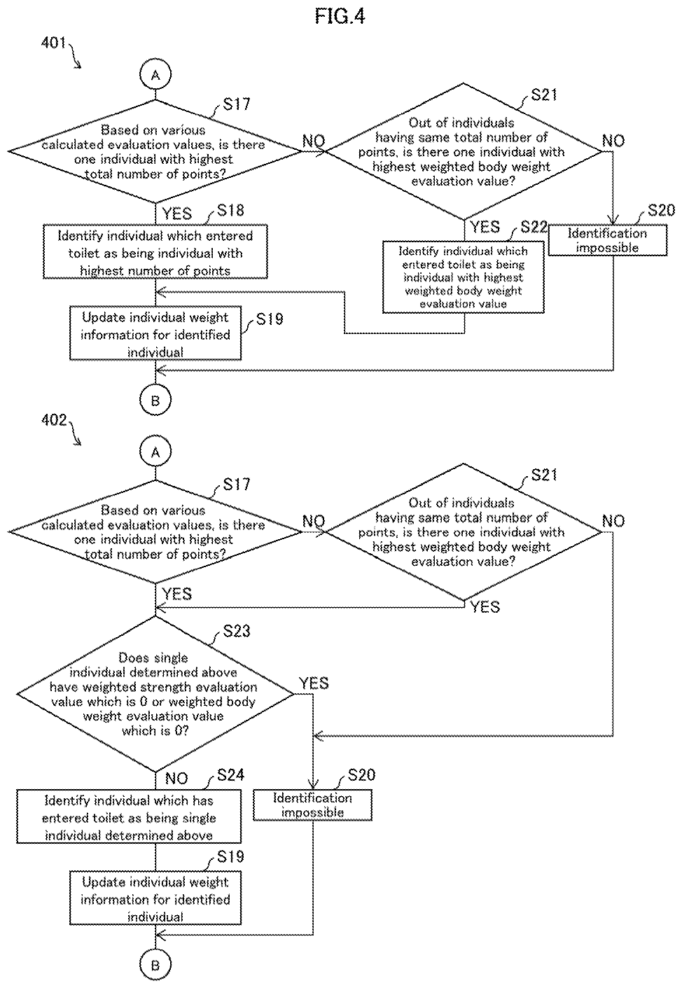

(d) An individual-identifying device in accordance with a variation of Embodiment 1 may carry out further processing in a case where, in S17 to S20 (see flowchart 302 of FIG. 3), there are a plurality of individuals having the highest total number of points. The following description will discuss a flow of such processing, with reference to flowchart 401 of FIG. 4. Note that steps involving processing similar to any step described above in Embodiment 1 will be given a similar reference number, and explanation of such will be omitted. Flowchart 401 of FIG. 4 illustrates processing carried out by an individual-confirming section in accordance with a variation of Embodiment 1. As illustrated in flowchart 401 of FIG. 4, in the case of “NO” in S17, the individual-confirming section 1344 further determines whether or not there is, out of the individuals having the same total number of points, one pet whose weighted body weight evaluation value is highest (S21). In the case of “YES” in S21, the individual-confirming section 1344 identifies the pet which has entered the animal toilet 1 as being the pet, among the individuals having the same total number of points, whose weighted body weight evaluation value is highest (S22). In the case of “NO” in S21, the individual-confirming section 1344 determines that the pet which has entered the animal toilet 1 cannot be identified (S20).

The above-described matters can be summarized as follows. The individual-confirming section calculates a total number of points by summing the various weighted evaluation values. The individual-confirming section is configured such that in a case where, based on the total number of points, the individual-confirming section determines that there are a plurality of possible candidates which may be identified as the pet which has entered the animal toilet 1, the individual-confirming section identifies the pet which has entered the animal toilet 1 as being a pet which, among the plurality of possible candidates, has the highest (most dominant) weighted body weight evaluation value. Note that in a case where the weighted evaluation value calculating section 1345 gives negative numbers as the evaluation values, the individual-confirming section can identify the pet which has entered the animal toilet 1 as being the pet whose weighted body weight evaluation value has the highest absolute value.

The individual-identifying device of the present variation makes it possible to identify the pet which has entered the animal toilet 1 on the basis of information indicating the weighted body weight evaluation values, even in a case where there are a plurality of pets having the highest total number of points. It is therefore possible to identify a pet with a high degree of accuracy and increase the frequency with which body weight information is updated.

(e) An individual-identifying device in accordance with a variation of Embodiment 1 may be configured such that the following processing is further carried out in addition to the processing described in variation (d) above. Flowchart 402 of FIG, 4 illustrates processing carried out by an individual-confirming section in accordance with another variation of Embodiment 1. As illustrated in flowchart 402 of FIG. 4, in the case of “YES” in S17 or “YES” in S21, the individual-confirming section 1344 determines whether or not the one pet that has been determined has a weighted strength evaluation value which is 0 or a weighted body weight evaluation value which is 0 (S23). In the case of “NO” in S23, the individual-confirming section 1344 identifies the pet which has entered the animal toilet 1 as being the above pet (S24). In the case of “YES” in S23, the individual-confirming section 1344 determines that the pet which has entered the animal toilet 1 cannot be identified (S20). The individual-identifying device of the present variation makes it possible to further increase the reliability of processing for identifying the pet which has entered the animal toilet 1. For example, in a case where the weighted body weight evaluation value is 0, because there is a large difference between the confirmed body weight value and the recorded body weight of the pet, it is likely that it would be incorrect to identify that pet as being the pet which has entered the animal toilet 1. The above configuration therefore makes it possible to identify the pet which has entered the animal toilet 1 with an even higher degree of accuracy. Note that, in S23, in a case where the weighted body weight evaluation value is 0 and the recorded weight of the pet being evaluated is also 0, the individual-confirming section may determine that the body weight of that pet is being measured for the first time. In such a case, in S23, the individual-confirming section can make an exception so that the pet being evaluated is not excluded as a possibility, and the processing can proceed to S24.

(f) The weighting information 155 is preferably configured so as to be alterable as necessary. The weighting information 155 may be updatable by the information updating section 16. Such a configuration makes it possible to address differing circumstances of cases where a user keeps a plurality of pets. In a case where a user keeps a plurality of pets whose body weights differ greatly from each other, identifying a pet based on body weight information is highly reliable. However, in a case where a user keeps a plurality of pet whose body weights are approximately the same, identifying a pet based on signal information is more reliable than identification based on body weight information. As such, altering weighting in accordance with the circumstances of the plural pet keeping makes it possible to identify a pet which has entered the animal toilet 1 with an even higher degree of accuracy.

Furthermore, body weight information can be weighted to a greater degree than signal information, or vice versa.

(g) The individual-identifying device of Embodiment 1 was exemplified as calculating a total number of points by summing positive evaluation values. However, based on the above technical ideas, an individual-identifying device in accordance with one variation can be configured so as to calculate a total number of points from evaluation values which are negative. In such a case, processing to identify an individual may accordingly be based on the size of a negative total number of points. The scope of the present invention of course includes an individual-identifying device which carries out such processing.

### Embodiment 2

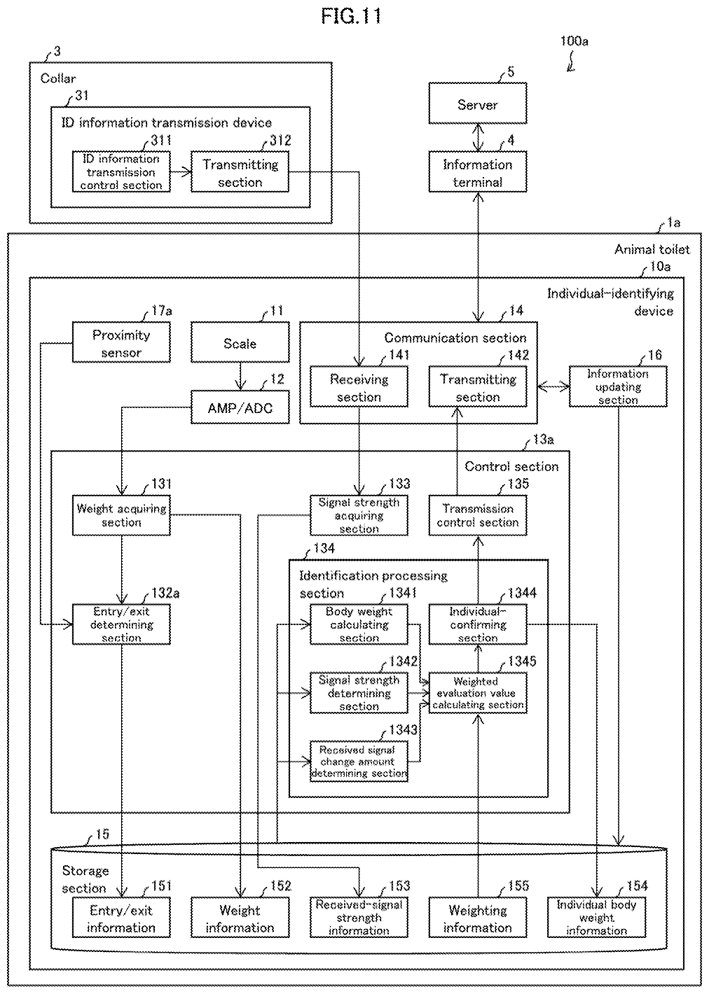

With reference to FIGS. 11 to 13, the following description will discuss another embodiment of the present invention. For convenience of explanation, the same reference numerals are given to members having functions identical with those described in the above embodiment, and descriptions of such members are omitted.

An animal toilet 1a according to Embodiment 2 includes an individual-identifying device 10a instead of the individual-identifying device 10 described in. Embodiment 1. The individual-identifying device 10a confirms the timing of when a pet enters/exits an animal toilet 1a with use of detection values (output) from a proximity sensor 17a.

(Configuration of Pet Management System 100a)

The following description will discuss a configuration of a pet management system 100a in accordance with Embodiment 2. FIG. 11 is a block diagram illustrating a configuration of main parts of the pet management system 100a in accordance with Embodiment 2, which identifies, from among a plurality of pets, a pet which has entered a predetermined region. As illustrated in FIG. 11, the pet management system 100a includes an animal toilet 1a, a collar 3, an information terminal 4, and a server 5.

(Individual-Identifying Device 10a)

As illustrated in FIG. 11, the individual-identifying device 10a includes a proximity sensor 17a in addition to the members of the individual-identifying device 10 of Embodiment 1. The proximity sensor 17a is provided so as to be able to detect an animal in the animal toilet 1a. In particular, in Embodiment 2, the proximity sensor 17a detects a pet in proximity to the animal toilet 1a. The proximity sensor 17a transmits a detected value to an entry/exit determining section 132a. A control section 13a includes an entry/exit determining section 132a instead of the entry/exit determining section 132 described in Embodiment 1. Except for this difference, the control section 13a is configured similarly to the control section 13 of Embodiment 1.

(Entry/Exit Determining Section 132a; Flow of Processing Carried Out by Entry/Exit Determining Section 132a)

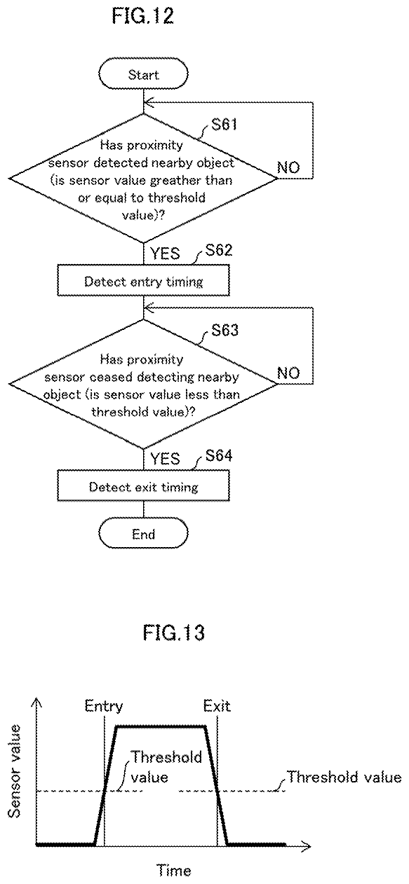

The entry/exit determining section 132a detects that a pet has entered the animal toilet 1, on the basis of a detected value from the proximity sensor 17a. Specifically, the entry exit determining section 132a confirms the timing of when a pet has entered/exited the animal toilet 1 with use of a detected value from the proximity sensor 17a. A flow of processing carried out by the entry/exit determining section 132a will be described here with reference to FIGS. 12 and 13. FIG. 12 is a flowchart illustrating an example of processing carried out by the entry/exit determining section 132a. FIG. 13 is a diagram illustrating examples of detected values (sensor values) as detected by the proximity sensor 17a.

As illustrated in FIG. 12, the entry/exit determining section 132a determines whether or not the proximity sensor 17a has detected a nearby object. Specifically, the entry/exit determining section 132a determines whether or not a sensor value received from the proximity sensor 17a is greater than or equal to a threshold value (S61). As illustrated in FIG. 13, in a case where the received sensor value is greater than or equal to the threshold value (“YES” in S61), the entry/exit determining section 132a confirms a time point at which the received sensor value became greater than or equal to the threshold value as being the timing of when a pet entered the animal toilet 1 a (entry timing detection) (S62). Next, the entry/exit determining section 132a determines whether or not the proximity sensor 17a has ceased detecting a nearby object. Specifically, the entry/exit determining section 132a determines whether or not a sensor value received from the proximity sensor 17a is less than the threshold value (S63). As illustrated in FIG. 13, in a case where a received sensor value is less than threshold value (“YES” in S63), the entry/exit determining section 132a confirms a time point at which the received sensor value became less than the threshold value as being the timing of when the pet exited the animal toilet 1a (exit tinning detection) (S64). In a case where, in S61, the received sensor value is less than the threshold value (“NO” in S61), the processing returns to S61. In a case where, in S63, the received sensor value is greater than or equal to the threshold value (“NO” in S63), the processing returns to S63. After confirming the timing of entry/exit, the entry/exit determining section 132a updates the entry/exit information 151 stored in the storage section 15. After confirming the timing of entry/exit, the entry/exit determining section 132a transmits, to the identification processing section 134, notification that the timing of entry/exit has been confirmed.

Note that, instead of using a detected value from the proximity sensor 17a, the entry/exit determining section 132a may be configured to detect that a pet has entered the animal toilet 1 on the basis of the strength, at the animal toilet 1, of a signal transmitted by an ID information transmission device 31.

### Embodiment 3

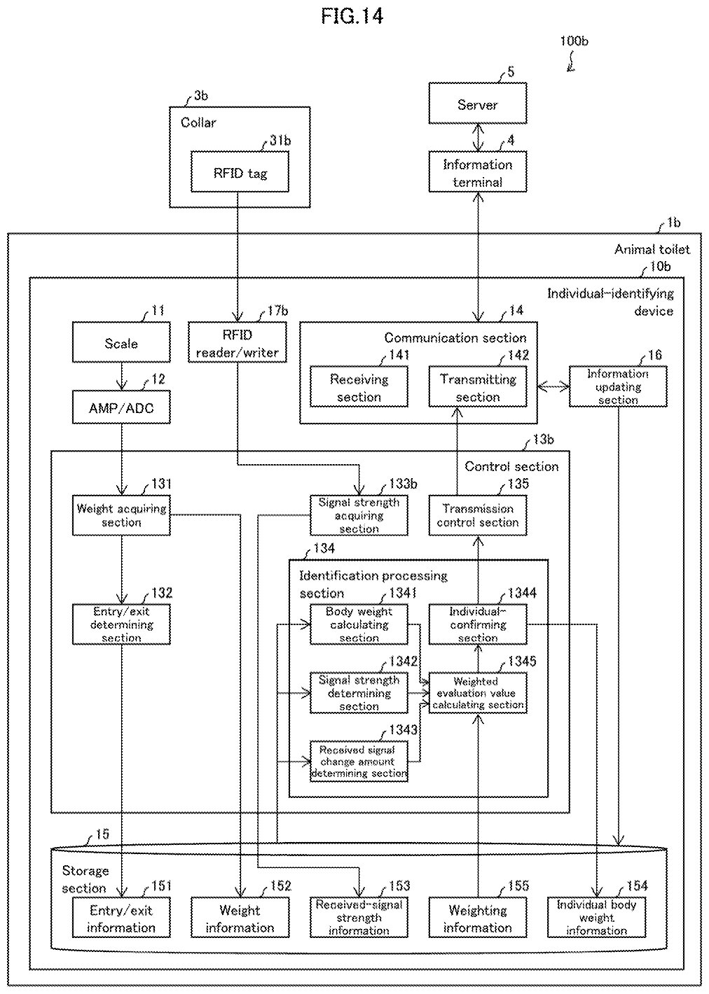

With reference to FIG. 14, the following description will discuss another embodiment of the present invention. For convenience of explanation, the same reference numerals are given to members having functions identical with those described in the above embodiments, and descriptions of such members are omitted.

A collar 3b in accordance with Embodiment 3 includes a radio frequency identifier (RFID) tag 31b which sends out ID information of a pet. A pet management system 100b includes an individual-identifying device 10b. The individual-identifying device 10b identifies, from among a plurality of pets, a pet which has entered an animal toilet 1b, with use of strengths of signals received from RFID tags 31b (instead of from ID information transmission devices 31 described in Embodiment 1).

(Configuration of Pet Management System 100b)

The following description will discuss a configuration of the pet management system 100b in accordance with Embodiment 3. FIG. 14 is a block diagram illustrating a configuration of main parts of the pet management system 100b in accordance with Embodiment 3, which identifies, from among a plurality of pets, a pet which has entered the animal toilet 1b. As illustrated in FIG. 14, the pet management system 100b includes the animal toilet 1b, the collar 3b, an information terminal 4, and a server 5.

(Collar 3b)

As described above, the collar 3b includes the RFID tag 31b. For each pet wearing a collar 3b, the RFID tag 31b transmits, to the individual-identifying device lob, a signal containing identification (ID) information of that pet.

(Individual-Identifying Device 10b)

As illustrated in FIG. 14, the individual-identifying device 10b includes a scale 11, an amp and ADC 12, a control section 13b, a communication section 14, a storage section 15, and an RFID reader/writer 17b. The RFID reader/writer 17b receives a signal transmitted by the RFID tag 31b. The RFID reader/writer 17b also detects the strength of the signal received from the RFID tag 31b.

The control section 13b includes a signal strength acquiring section 133b instead of the signal strength acquiring section 133 described in Embodiment 1. The signal strength acquiring section 133b receives (i) information indicating the strength of a signal detected by the RFID reader/writer 17b and (ii) identification information indicated by that signal. The signal strength acquiring section 133b updates received-signal strength information 153, which (i) is stored in the storage section 15 and (ii) indicates the strength of the signal received from the RFID tag 31b in association with a time of reception.

It will be understood that the processing carried out by the individual-identifying device 10b of Embodiment 3 is similar to the processing described in Embodiment 1, except that the ID information transmission device 31 and the receiving section 141 of the individual-identifying device 10 of Embodiment 1 are replaced by the RFID tag 31b and the RFID reader/writer 17b, respectively.

[Software Implementation Example]

Control blocks of the individual-identifying devices 10, 10a, and 10b (in particular, the control sections 13, 13a, and 13b) can be realized by a logic circuit (hardware) provided in an integrated circuit (IC chip) or the like or can be alternatively realized by software as executed by a central processing unit (CPU).

In the latter case, the individual-identifying devices 10, 10a, and 10b each include: a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass a “non-transitory tangible medium” such as a tape, a disk, a card, a semiconductor memory, and a programmable logic circuit. The program can be supplied or made available to the computer via any transmission medium (such as a communication network or a broadcast wave) which allows the program to be transmitted. Note that an aspect of the present invention can be achieved in the form of a computer data signal in which the program is embodied via electronic transmission and which is embedded in a carrier wave.

[Recap]

An animal identifying device in accordance with Aspect 1 of the present invention includes: a body weight calculating section which calculates a body weight of an unidentified animal among a measurement target animal group constituted by a plurality of animals which are subject to body weight measurement, the body weight calculating section calculating the body weight of the unidentified animal on the basis of weight information from a measurement carried out while the unidentified animal is in a predetermined region; a signal strength acquiring section which acquires information indicating a strength of each of a plurality of signals respectively transmitted from a plurality of transmission devices respectively worn by the plurality of animals constituting the measurement target animal group; a signal information determining section which determines identity-determining signal information for identifying the unidentified animal, the identity-determining signal information being based on the respective strength of each signal received; a weighted evaluation value calculating section which calculates (i) weighted body weight evaluation values, which are weighted in accordance with the body weight of the unidentified animal and (ii) weighted signal evaluation values, which are weighted in accordance with the identity-determining signal information; and an individual-identifying section which identifies the unidentified animal which has entered the predetermined region on the basis of the weighted body weight evaluation values and the weighted signal evaluation values.

In Aspect 2 of the present invention, the animal identifying device of Aspect 1 may be configured such that: the identity-determining signal information includes occupancy period signal strength information which indicates a strength of each signal received from the plurality of transmission devices as observed while the unidentified animal is in the predetermined region; the weighted signal evaluation values include weighted strength evaluation values which are weighted in accordance with the occupancy period signal strength information; and the weighted evaluation value calculating section is configured to (i) calculate, from the occupancy period signal strength information, respective differences in strength between (a) a signal which has a highest strength among the signals received from the plurality of transmission devices and (b) each of the rest of the signals received, and (ii) calculate the weighted strength evaluation values on the basis of the respective differences in strength thus calculated and a predetermined weighting criterion.

In Aspect 3 of the present invention, the animal identifying device of Aspect 1 or 2 may be configured such that: the weighted evaluation value calculating section calculates the weighted body weight evaluation values on the basis of (i) the body weight of the unidentified animal, (ii) individual weight information which indicates respective body weights of the plurality of animals of the measurement target animal group, and (iii) a predetermined weighting criterion.

In Aspect 4 of the present invention, the animal identifying device of any one of Aspects 1 to 3 may be configured such that: the identity-determining signal information includes signal strength change amount information which, for each signal received from the plurality of transmission devices, indicates an amount of change between (i) the strength of that signal as observed prior to when the unidentified animal in the predetermined region exits the predetermined region and (ii) the strength of that signal as observed after the unidentified animal exits the predetermined region; the weighted signal evaluation values include weighted strength change amount evaluation values which are weighted in accordance with the signal strength change amount information; and the weighted evaluation value calculating section calculates the weighted strength change amount evaluation values on the basis of the signal strength change amount information and a predetermined weighting criterion.

In Aspect 5 of the present invention, the animal identifying device of any one of Aspects 1 to 4 may be configured such that the individual-identifying section is configured to (i) calculate, for each of the plurality of animals of the measurement target animal group, a total number of points by summing the weighted body weight evaluation value and the weighted signal evaluation value for that animal, and (ii) in a case where, based on the respective total number of points of each of the plurality of animals, the individual-identifying section determines that there are a plurality of possible candidates which may be identified as the unidentified animal which has entered the predetermined region, identify the unidentified animal which has entered the predetermined region as being an animal which, among the plurality of possible candidates, has the most dominant weighted body weight evaluation value.

A method in accordance with Aspect 6 of the present invention is a method of controlling an animal identifying device, the method including: a body weight calculation step of calculating a body weight of an unidentified animal among a measurement target animal group constituted by a plurality of animals which are subject to body weight measurement, the body weight of the unidentified animal being calculated on the basis of weight information from a measurement carried out while the unidentified animal is in a predetermined region; a signal strength acquisition step of acquiring information indicating a strength of each of a plurality of signals respectively transmitted from a plurality of transmission devices respectively worn by the plurality of animals constituting the measurement target animal group; a signal information determination step of determining identity-determining signal information for identifying the unidentified animal, the identity-determining signal information being based on the respective strength of each signal received; a weighted evaluation value calculation step of calculating (i) weighted body weight evaluation values, which are weighted in accordance with the body weight of the unidentified animal and (ii) weighted signal evaluation values, which are weighted in accordance with the identity-determining signal information; and an individual identification step of identifying the unidentified animal which has entered the predetermined region on the basis of the weighted body weight evaluation values and the weighted signal evaluation values.

The animal identifying device in accordance with each aspect of the present invention may be realized by a computer. The scope of the present invention therefore encompasses a control program for the animal identifying device which program realizes the animal identifying device in the form of a computer by causing the computer to operate as each section (software element) of the animal identifying device, and a computer-readable storage medium in which the control program is stored.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1a, 1b Animal toilet (predetermined region)

10, 10a, 10b Individual-identifying device identifying device)

31 ID information transmission device (transmission device)

131: Weight acquiring section

133: Signal strength acquiring section

134, 134b: Identification processing section

1341: Body weight calculating section

1342: Signal strength determining section (signal information determining section)

1343: Received signal change amount determining section (signal information determining section)

1344: Individual-confirming section (individual-identifying section)

1345: Weighted evaluation value calculating section

1. An animal identifying device comprising:
a body weight calculating section which calculates a body weight of an unidentified animal among a measurement target animal group constituted by a plurality of animals which are subject to body weight measurement, the body weight calculating section calculating the body weight of the unidentified animal on the basis of weight information from a measurement carried out while the unidentified animal is in a predetermined region;
a signal strength acquiring section which acquires information indicating a strength of each of a plurality of signals respectively transmitted from a plurality of transmission devices respectively worn by the plurality of animals constituting the measurement target animal group;
a signal information determining section which determines identity-determining signal information for identifying the unidentified animal, the identity-determining signal information being based on the respective strength of each signal received;
a weighted evaluation value calculating section which calculates (i) weighted body weight evaluation values, which are weighted in accordance with the body weight of the unidentified animal and (ii) weighted signal evaluation values, which are weighted in accordance with the identity-determining signal information; and
an individual-identifying section which identifies the unidentified animal which has entered the predetermined region on the basis of the weighted body weight evaluation values and the weighted signal evaluation values.

2. The animal identifying device according to claim 1, wherein:
the identity-determining signal information includes occupancy period signal strength information which indicates a strength of each signal received from the plurality of transmission devices as observed while the unidentified animal is in the predetermined region;
the weighted signal evaluation values include weighted strength evaluation values which are weighted in accordance with the occupancy period signal strength information; and
the weighted evaluation value calculating section is configured to (i) calculate, from the occupancy period signal strength information, respective differences in strength between (a) a signal which has a highest strength among the signals received from the plurality of transmission devices and (b) each of the rest of the signals received, and (ii) calculate the weighted strength evaluation values on the basis of the respective differences in strength thus calculated and a predetermined weighting criterion.

3. The animal identifying device according to claim 1, wherein:
the weighted evaluation value calculating section calculates the weighted body weight evaluation values on the basis of (i) the body weight of the unidentified animal, (ii) individual weight information which indicates respective body weights of the plurality of animals of the measurement target animal group, and (iii) a predetermined weighting criterion.

4. The animal identifying device according to claim 1, wherein:
the identity-determining signal information includes signal strength change amount information which, for each signal received from the plurality of transmission devices, indicates an amount of change between (i) the strength of that signal as observed prior to when the unidentified animal in the predetermined region exits the predetermined region and (ii) the strength of that signal as observed after the unidentified animal exits the predetermined region;
the weighted signal evaluation values include weighted strength change amount evaluation values which are weighted in accordance with the signal strength change amount information; and
the weighted evaluation value calculating section calculates the weighted strength change amount evaluation values on the basis of the signal strength change amount information and a predetermined weighting criterion.

5. The animal identifying device according to claim 1, wherein the individual-identifying section is configured to (i) calculate, for each of the plurality of animals of the measurement target animal group, a total number of points by summing the weighted body weight evaluation value and the weighted signal evaluation value for that animal, and (ii) in a case where, based on the respective total number of points of each of the plurality of animals, the individual-identifying section determines that there are a plurality of possible candidates which may be identified as the unidentified animal which has entered the predetermined region, identify the unidentified animal which has entered the predetermined region as being an animal which, among the plurality of possible candidates, has the most dominant weighted body weight evaluation value.

6. A method of controlling an animal identifying device, the method comprising:
a body weight calculation step of calculating a body weight of an unidentified animal among a measurement target animal group constituted by a plurality of animals which are subject to body weight measurement, the body weight of the unidentified animal being calculated on the basis of weight information from a measurement carried out while the unidentified animal is in a predetermined region;
a signal strength acquisition step of acquiring information indicating a strength of each of a plurality of signals respectively transmitted from a plurality of transmission devices respectively worn by the plurality of animals constituting the measurement target animal group;
a signal information determination step of determining identity-determining signal information for identifying the unidentified animal, the identity-determining signal information being based on the respective strength of each signal received;
a weighted evaluation value calculation step of calculating (i) weighted body weight evaluation values, which are weighted in accordance with the body weight of the unidentified animal and (ii) weighted signal evaluation values, which are weighted in accordance with the identity-determining signal information; and
an individual identification step of identifying the unidentified animal which has entered the predetermined region on the basis of the weighted body weight evaluation values and the weighted signal evaluation values.

7. A non-transitory computer-readable storage medium that stores a control program for causing a computer to function as the animal identifying device recited in claim 1.
